(19) United States
(12) Patent Application Publication
(10) Pub. No.: US 2011/0027520 A1
(43) Pub. Date: Feb. 3, 2011

(54) METHOD FOR PRODUCING A FLOOR COVERING SUBSTRATE AND METHOD FOR PRODUCING A SUBSTRATE LAYER FOR A FLOOR COVERING SUBSTRATE COMPRISING AT LEAST ONE ELECTRONIC CONSTRUCTION ELEMENT INTEGRATED THEREIN

(75) Inventors: Christl Lauterbach, Hoehenkirchen-Siegertsbrunn (DE); Axel Steinhage, Kirchseeon (DE); Andre Bartel, Esslingen (DE)

Correspondence Address: ARENT FOX LLP, 1050 CONNECTICUT AVENUE, N.W., SUITE 400, WASHINGTON, DC, 20036, US

(73) Assignee: Future-Shape GmbH, Hoehenkirchen-Siegertsbrunn (DE)

(21) Appl. No.: 12/918,659

(22) PCT Filed: Feb. 20, 2009
(86) PCT No.: PCT/EP09/52072

§ 371 Date: Oct. 20, 2010

(30) Foreign Application Priority Data
Feb. 22, 2008 (DE) 10 2008 010 530.9

(51) Int. Cl. B32B 3/02; B32B 37/16; B32B 37/12; B32B 38/04; B32B 3/26; B32B 5/02; C09J 7/02; B32B 3/30

(52) U.S. Cl. 428/76; 156/60; 156/327; 156/298; 156/257; 428/304.4; 428/221; 442/1; 428/354; 428/172

(57) ABSTRACT

A method for producing a floor covering substrate is provided, wherein at least one electronic device is embedded within a layer, which includes at least one curable material; wherein the at least one electronic device is embedded in a substrate layer and/or on a substrate layer; wherein the substrate layer, including the electronic device, is embedded in a layer, which includes at least one curable material; wherein the substrate layer that includes a porous or meshed structure or a reinforcement fabric, which is penetrable for the at least one curable material.

The invention relates to a method for producing a floor covering substrate, a floor covering substrate, a method for the integration of at least one electronic device in a flooring, a flooring with at least one integrated electronic device, a method for producing a substrate layer for a floor covering substrate, as well as a substrate layer for a floor covering substrate.

RFID tags (Radio Frequency IDentification tags) integrated in a flooring, which can be inserted in the flooring in a regular grid, can be used as radio landmarks for the localisation of robot vehicles or other mobile devices. For this purpose, one takes advantage of the fact that each RFID tag has its own ID number, in other words, each RFID has its unique identifying information. After the installation of the RFID tags within the floor a kind of map can be generated, showing the actual physical position of each RFID tag within the floor.

The robot vehicles or other mobile objects, which are to be localized, are equipped with a reader for the RFID tags. Additionally, the mapping information is provided to their local or to a central control unit, respectively. Thus, the RFID readers are able to read the ID number of an RFID tag, every time when an RFID tag comes within the receiving range of the antenna of an RFID tag, and by using the mapping information, they are able to determine their exact position.

Examples for the localization and/or navigation by means of a floor equipped with integrated ID data storage devices are described in, for instance, [1], [2] and [3], as well as in [4], where a wet cleaning robot is described and in [5], where an autonomous driven fork lift truck is described.

So far, the integration of RFID tags in a flooring is usually done in that way, that the RFID tags are embedded in the floor one by one. In [6] it is described, for instance, that encapsulated RFID tags are embedded subsequently into drilled holes in the floor. This method requires a considerable effort in drilling the holes into the floor, inserting the RFID tags and sealing the holes, and the subsequent calibrating, as well as the creating of a mapping information.

For demonstration purposes RFID tags are often mounted directly on the floor pavement (floating screed), using a cold bonding adhesive layer beneath the floor coverings. For this, the floor pavement has to be as homogenous as possible, which can be achieved by using an additional filling on the floor pavement. As the grid of the RFID tags has to be as exact as possible, a profile board has to be created additionally prior to the integration of the RFID tags. There is a danger during this procedure of the integration of the RFID tags in the floor covering, that part of the RFID tags are destroyed mechanically or by the residual moisture in the floor pavement, especially present in new buildings, which destroys the electronics. In case of elastic floor coverings (e.g. carpet, PVC, rubber, linoleum) mechanical stress during use may lead to the breakdown of the RFID tags, in a short time. When installing RFID tags beneath tiles or stone flooring, the adhesive used for this flooring often destroys the RFID tags.

One possibility to equip a textile impact sound insulation or a carpet with a regular grid of RFID tags directly during the production is described in [7]. The system described in [7] is confined to carpet or parquet/laminate. However, especially in public or commercial buildings usually a large part of the floors are covered with stone flooring, tiles, artificial resin, terrazzo, PVC, rubber or linoleum, nowadays. Beneath all these floor coverings the textile impact sound insulation described in [7] is not feasible.

A problem, the invention is based on, is the easy and cost-efficient integration of REID tags and, respectively, generally electronic devices into the flooring and their reliable protection against all kind of stress, which is applied to them in the floor.

The problem is solved by a method for producing a floor covering substrate, a floor covering substrate, a method for the integration of at least one electronic device in a flooring, a flooring with at least one integrated electronic device, a method for producing a substrate layer for a floor covering substrate, as well as a substrate layer for a floor covering substrate with the features according to the independent patent claims.

Exemplary embodiments of the invention result from the dependent patent claims. Further embodiments of the invention, described in combination with the method for producing a floor covering substrate, are correspondingly valid and as far as sensible, as well for the floor covering substrate, the method for integration of at least one electronic device in the flooring, the flooring, the method for producing the substrate layer for the floor covering substrate, as well as the substrate layer.

In a method for producing a floor covering substrate according to one embodiment, at least one electronic device is embedded within a layer having at least one curable material.

A floor covering substrate according to an alternative embodiment includes a layer, which possesses at least one curable material. The floor covering substrate further includes at least one electronic device, which is embedded within the layer.

A curable material or hardening material in line with this application can be comprehended for example as a material which from a first state of low viscosity (illustratively, a state in which the material is shapeable, for instance liquid, pourable, spreadable or smoothable) is, mainly irreversible, transformable into a second state of high viscosity (for instance through heating or a temper process), resulting for the material to be in this second state with a higher viscosity inherently stable or rigid. This transition can be described as the curing of the material.

According to one embodiment, the curable material of the layer in its first state can be handled or processed and afterwards be transformed into a second state (e.g. the layer can be cured). For instance, it is possible to embed the at least one electronic device into the (not yet cured) layer and afterwards through curing of this layer produce a solid and free of play encapsulation. The layer, which includes the at least one curable material, will be named also as curable layer in the following.

According to an embodiment the at least one curable material includes at least one of the following materials: an artificial resin material (e.g. epoxy resin or a composition of epoxy resins), dispersion adhesive material, a mineral prime coat (e.g. concrete or cement). As an alternative other suitable curable materials can be used.

Epoxy resin in this context can be understood as an artificial resin, consisting of polymers, which, depending on the kind. of chemical reaction under the addition of suitable curing agents, develop into a thermosetting plastic of high stability and chemical resistance. When mixing epoxy resin and curing agent, a curing process starts, which leads to a hardening of the previously liquid material, within a span of time of between a few minutes and/or up to some hours, depending on the chemical composition and the temperature. In some case more time elapses until the epoxy resin is completely cured.

According to another embodiment the thickness of the curable layer (e.g. the thickness of an artificial resin layer) in which the electronic device is embedded, is approximately 0.2 mm up to 2 cm, for instance approximately 2 mm. Alternatively, the layer may have a different thickness.

According to another embodiment, the at least one electronic device is applied to and/or at least partly into a first sublayer which includes a first curable material. Then a second sublayer including a second curable material is applied to the first sublayer and the electronic device in such a way that the layer with the therein embedded electronic device is formed. The first curable material and the second curable material may in this case be the same material. Alternatively, the second curable material can be a different curable material than the first curable material. In the following, the first sublayer will be described in the following also as a first curable sublayer, and the second sublayer will be described in the following as a second curable sublayer.

Illustratively, according to the above-described embodiment, a first curable sublayer may be provided and the electronic device is applied to the first (not yet cured) sublayer and/or at least partly embedded therein. Subsequently, a second curable sublayer is applied to the first sublayer and to the therein applied and/or embedded electronic device in such a way, that the device is located between both sublayers and accordingly embedded between them. Subsequently, the first sublayer and the second sublayer can be cured in such a way, that the electronic device is embedded solidly (in other words free from play) between the cured sublayers.

According to another embodiment the first curable material and/or the second curable material include at least one of the following materials: an artificial resin material (e.g. an epoxy resin or compositions of epoxy resins), a dispersion adhesive material, a mineral prime coat (e.g. concrete or cement). As an alternative other suitable curable materials may be used.

According to another embodiment the at least one electronic device is embedded in a substrate layer and/or applied to the substrate layer, and the substrate layer, including the electronic device is embedded into the layer, which includes at least one curable material. Illustratively, the embedding and/or applying of the electronic device in the substrate layer and/or on the substrate layer is possible before the embedding of the substrate layer within the layer.

According to another embodiment, a plurality of electronic devices is embedded in the substrate layer and/or applied on the substrate layer, for instance in a regular grid. In other words, the electronic devices may be arranged in a regular grid (e.g. a rectangular grid or a quadratic grid) in and/or on the substrate layer. The individual devices can have a distance between each other of approximately 10 cm up to 1 m, for instance approximately 30 cm up to 70 cm, for instance approximately 50 cm, according to one embodiment. Alternatively, the devices may have a different distance to one another, according to the planned application.

Further it is possible, that the distance of the devices is variable. For instance, it is possible that, in the case of RFID tags being the electronic devices within the substrate layer, the distance between them may vary according to the desired accuracy of the localization/navigation, for instance in that way, that in a first subarea of the substrate layer, the RFID tags have a first distance between each other and in a second subarea of the substrate layer have a second distance between each other, at which the second distance for instance can be smaller than the first instance. This is leading to the accuracy of the localization/navigation of the second subarea being higher.

According to one embodiment, the substrate layer including the embedded therein or applied to electronic devices, is installed on the first curable sublayer and the second curable sublayer is applied to the substrate layer.

According to another embodiment, the substrate layer includes a porous (in other words, a penetrable) structure. In other words, the substrate layer may include a porous (penetrable) material or may consist of the same.

In the context of this application, a porous or penetrable material may be interpreted in general, as a material, which is at least partly porous for another material or may at least partly be penetrated by another material. In particular, a porous material may be interpreted as a material, which for instance is porous at least partly for the at least one curable material and, respectively may at least partly be penetrated by it.

For instance, the porous material may be porous for the first curable material of the first curable sublayer and/or the second curable material of the second curable sublayer may be at least partly porous and accordingly may be penetrated at least partly by the first and/or second curable material. In other words, the porous structure may be designed in a way that during the applying of the substrate layer on the first curable sublayer and/or during the applying of the second curable sublayer on the substrate layer, the material of the first curable sublayer and/or the material of the second curable sublayer is able to at least partly penetrate through the porous structure of the substrate layer, thus allowing the materials of the first and the second curable sublayer to get in contact with each other through the substrate layer and therefore achieving a permanent joint between the sublayers after the curing of both sublayers.

According to one embodiment, the porous structure may include porous or penetrable openings (also called holes) for another material (for instance, for at least one curable material), wherein the holes possess sizes (for instance a diameter) of approximately 1 mm up to 50 mm, for instance approximately 3 mm up to 10 mm, for instance approximately 5 mm. Alternatively, the sizes of the holes may have other values.

According to one embodiment, the porous material may be for instance, a scrim fabric from glass fibre, carbon fibre, metal wire, Polyester, Polyethylene, or foils, metal sheets or paper including stamped or perforated holes. Alternatively other materials may be used.

According to another embodiment, the substrate layer includes a meshed structure. In other words, the substrate layer includes a material with a meshed structure (for instance a meshed fabric) or consists of a meshed fabric.

The mesh width of the meshed structure may be designed in a way, that the meshed structure is at least partly porous for the first curable material of the first curable sublayer and/or the second curable material of the second curable sublayer. In other words, the mesh width may be designed in a way that during the application of the substrate layer on the first curable sublayer and/or during the application of the second curable sublayer on the substrate layer, the material of the first curable sublayer and/or the material of the second curable sublayer is able to at least partly penetrate through the meshes of the substrate layer, thus allowing the materials of the first and the second curable sublayer to get in contact with each other through the substrate layer and, therefore, achieving a permanent joint between the sublayers after the curing of both sublayers.

According to one embodiment, the mesh width is for instance approximately 1 mm up to 50 mm, for instance approximately 3 mm up to 10 mm, for instance approximately 5 mm. Alternatively, the mesh width may have a different value.

According to another embodiment, the substrate layer is a reinforcement fabric. In this context, a reinforcement fabric may be comprehended as a fabric or a textile structure that is installed (embedded) for the reinforcing (also called reinforcement or strengthening) of a floor covering or a floor pavement (floor screed) or generally a layer within the floor covering, respectively within the floor screed or within the layer. For instance, a reinforcement fabric may possess a higher tensile strength and/or compression strength compared to the object that should be strengthened, and/or a higher endurance against other influences (e.g. environmental impacts like water, frost, chemical substances, etc.).

According to one embodiment, the reinforcement fabric includes at least one of the following materials: a glass fibre material, polyethylene, polypropylene, polyester, a carbon fibre material, a natural fibre material, In other words, the reinforcement fabric may include one or several of the above-named materials or consist of the same.

According to another embodiment, the curable layer is applied to the substrate layer (e.g. the reinforcement fabric) that includes the embedded in, respectively the applied on electronic devices. If the substrate layer includes a meshed structure or a porous structure, then the material of the curable layer (e.g. an artificial resin layer) is at least partly able to penetrate through the meshes, respectively the holes of the substrate layer and make contact to the layer beneath the substrate layer (e.g. a floor pavement like floor screed) and form a permanent joint with this layer after curing. Simultaneously, the substrate layer may be embedded solidly (respectively play-free) within the curable layer.

According to another embodiment, at least one recess is formed within the substrate layer and the at least one electronic device is integrated into the at least one recess.

According to one embodiment, the shape and size of the recess may be adapted to the electronic device, which will be integrated therein. Descriptively, by means of the recess, a height compensation may be achieved between the substrate layer and the at least one therein integrated electronic device.

According to another embodiment, at least one recess is formed by one of the following methods: laser beam cutting, stamping, cutting, milling. Alternatively, other suitable methods for forming recesses may be used.

According to another embodiment, the at least one electronic device is encapsulated, using an encapsulation coating (for instance a plastic layer), previous to the embedding into the curable layer. In other words, the electronic device is laminated with the encapsulation layer. By means of the encapsulation (also called encasing) respectively lamination it is possible, for instance, to achieve a height compensation between the separate components of the electronic device.

Further, the electronic device can be protected against mechanical and/or chemical influences and/or humidity by means of the encapsulation layer.

According to another embodiment, the at least one electronic device is encapsulated with the encapsulation layer, previous to its embedding into the substrate layer and/or its application on the substrate layer.

According to another embodiment, the at least one electronic device is glued to the substrate layer by using the encapsulation layer.

According to another embodiment, the at least one electronic device is a radio identification data storage medium (also called RFID tag), for instance an RFID tag, for instance a passive RFID tag. The RFID tag may possess a unique identification information (ID number), which for instance can be read by a suitable reader, which is brought close to the RFID tag or bypassing it closely.

According to another embodiment, a floor covering substrate is provided for a method for the integration of at least one integrated electronic device into flooring. Further a floor covering is installed above the floor covering substrate.

According to another embodiment, a flooring with at least one electronic device includes a floor covering substrate, as well as a floor covering, which is installed on the floor covering substrate.

The floor covering substrate may be formed, respectively be, according to one embodiment described herein. The floor covering may be a common floor covering like for instance, stone flooring, tiles, concrete, artificial resin, Terrazzo, PVC, linoleum, carpet, parquet, laminate and other elastic flooring, with the exception of metal.

According to another embodiment, a substrate layer is provided, which includes a porous or a meshed structure, for a method to produce a substrate layer for a floor covering substrate. Further at least one electronic device is embedded in the substrate layer and/or applied on the substrate layer.

A substrate layer for a floor covering substrate according to another embodiment includes at least one electronic device, which is embedded in the substrate layer and/or applied on the substrate layer, wherein the substrate layer includes a porous structure or a meshed structure.

The substrate layer may be formed according to one of the herein described embodiments, respectively it can be one.

Embodiments of the invention are depicted in the figures und will be described in detail in the following. The same or similar elements within the figures are indicated, as far as sensible, with the same or identical reference signs. The drawings in the figures are schematic and, therefore, not true to scale.

It is shown in

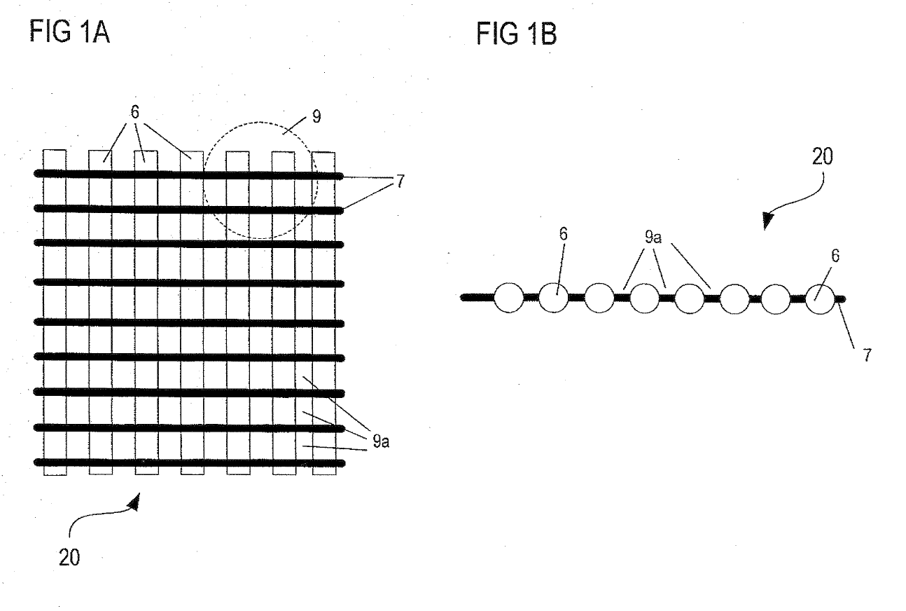

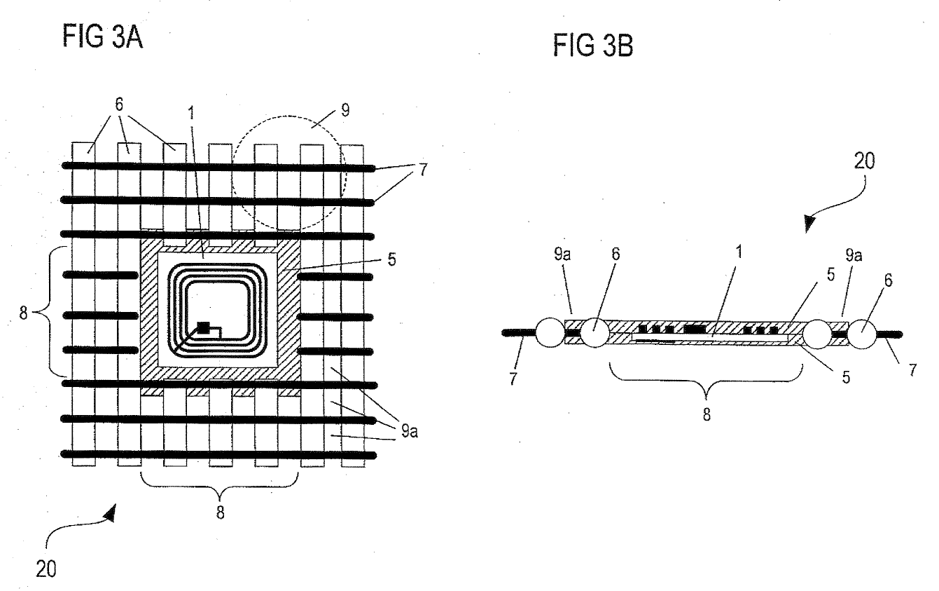

FIG. 1A up to FIG. 3B a method for producing a substrate layer for a floor covering substrate according to one embodiment;

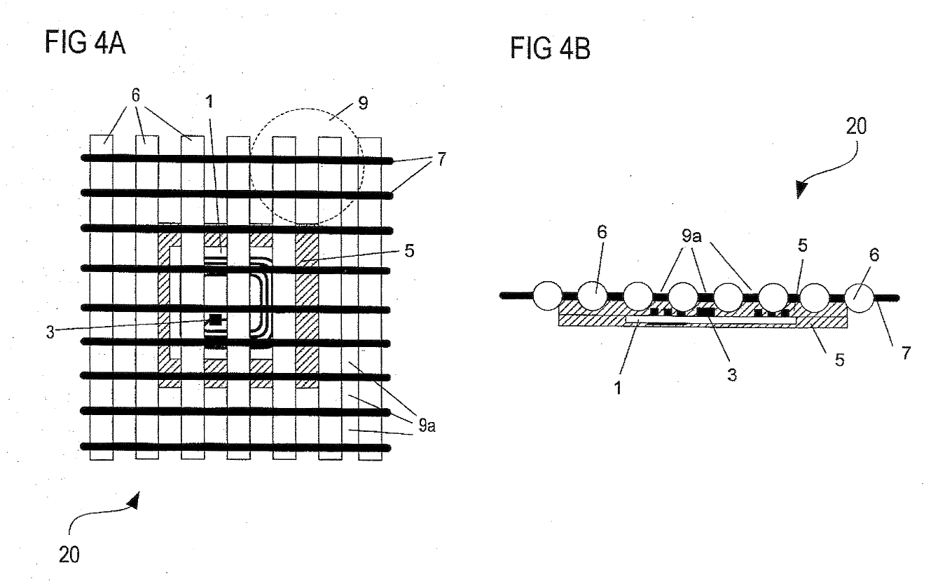

FIG. 4A and FIG. 4B a method for producing a substrate layer for a floor covering substrate according to another embodiment;

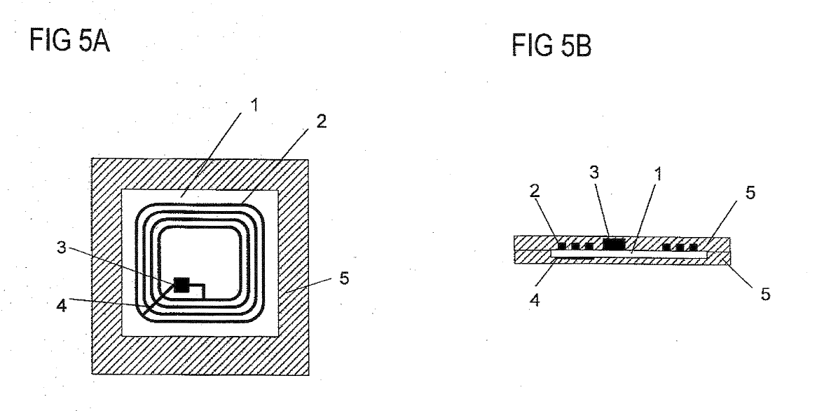

FIG. 5A up and FIG. 5B an REID tag for use in a floor covering substrate, according to one embodiment;

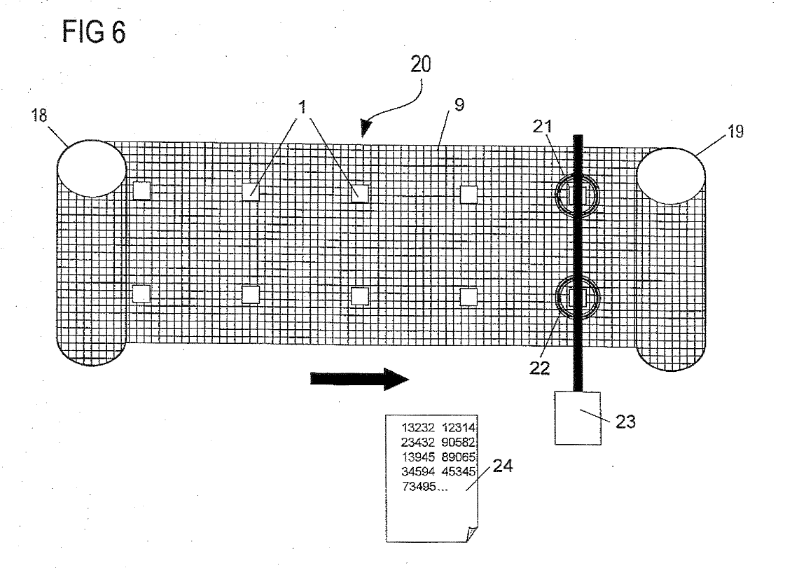

FIG. 6 a schematic drawing of a mapping of REID tags integrated within a substrate layer according to another embodiment;

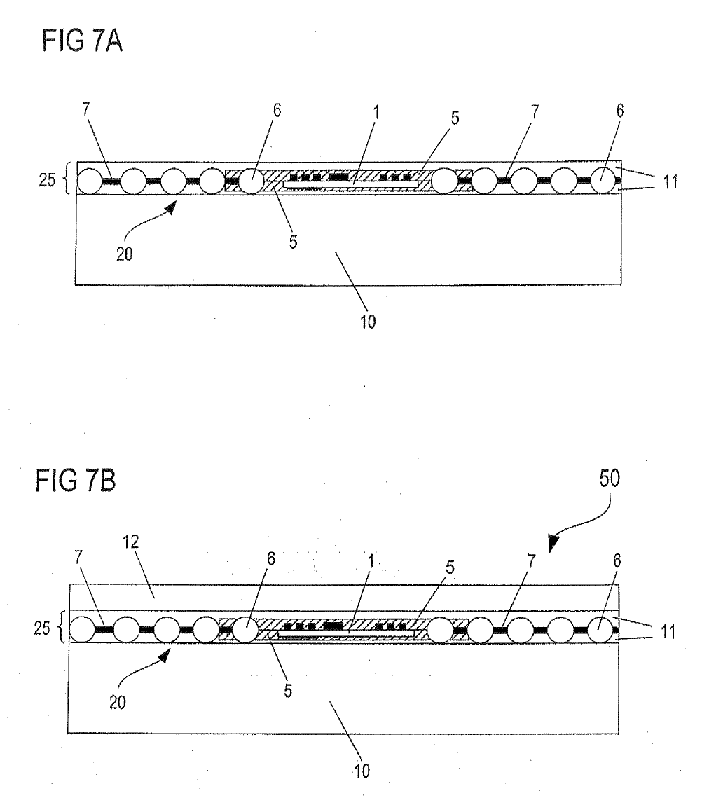

FIG. 7A a method for producing a floor covering substrate according to one embodiment;

FIG. 7B a flooring with a floor covering substrate according to another embodiment;

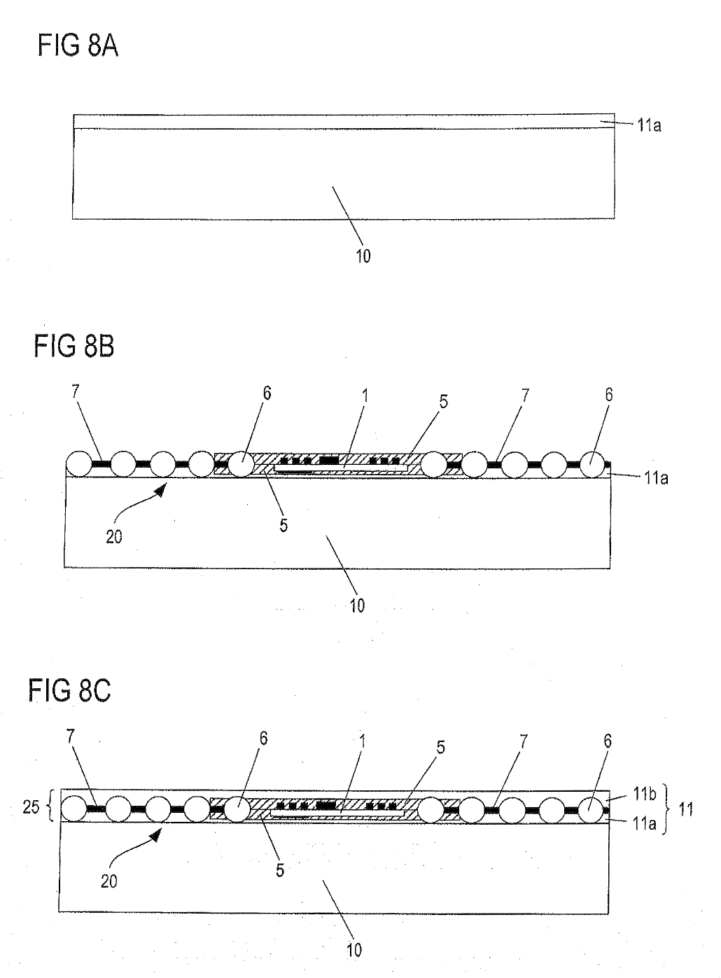

FIG. 8A up to FIG. 8C a method for producing a floor covering substrate according to another embodiment;

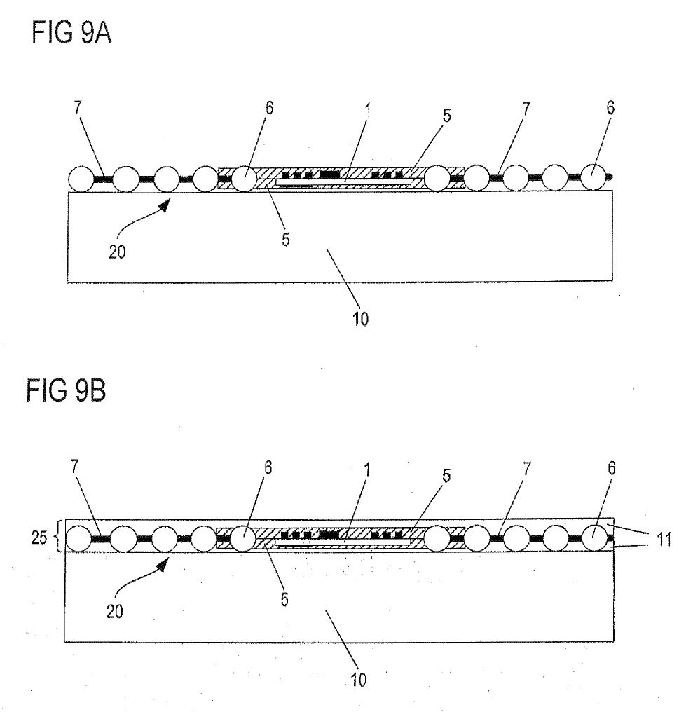

FIG. 9A and FIG. 9B a method for producing a floor covering substrate according to another embodiment;

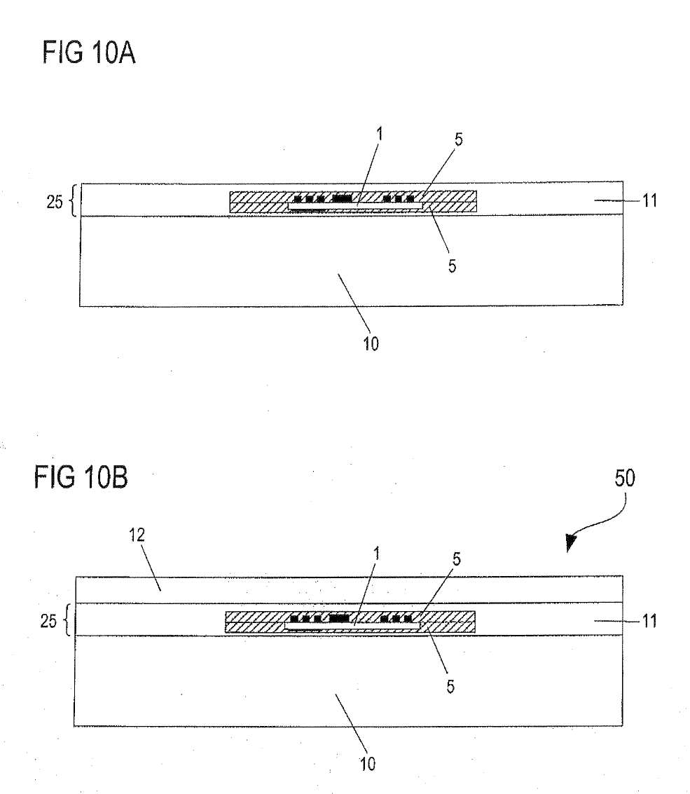

FIG. 10A a method for producing a floor covering substrate according to another embodiment;

FIG. 10B a flooring comprising a floor covering substrate according to another embodiment.

In the following with reference to FIG. 1A up to FIG. 3B a method is described for producing a substrate layer for a floor covering substrate according to one embodiment.

According to this embodiment a substrate layer 20 is provided. FIG. 1A and FIG. 1B illustrate a detail of the substrate layer 20 from top view (FIG. 1A) and in cross section (FIG. 1B). The substrate layer 20 includes a reinforcement fabric 9 with a meshed structure. According to the depicted embodiment herein, the reinforcement fabric 9 is constructed of a glass fibre fabric. Alternatively, the reinforcement fabric possesses other materials like, e.g. polyethylene, polypropylene, polyester, carbon fibres, natural fibres or metal wires. The glass fibre fabric 9 includes first glass fibres 6, which are arranged in a first direction (e.g. fill direction), as well as second glass fibres 7, which are arranged in a second direction (according to the depicted embodiment in a right angle to the first direction, for instance in warp direction). Further, the glass fibre fabric 9 includes a plurality of meshes 9a, which are formed between the glass fibres 6, 7.

The glass fibre fabric 9 of the substrate layer 20 may include, for instance, a thickness of approximately 0.1 mm up to 5 mm, for instance approximately 0.2 mm up to 1 mm, for instance 0.45 mm according to one embodiment. The glass fibre fabric 9 may include a mesh width of for instance, approximately 1 mm up to 50 mm, for instance approximately 3 mm up to 10 mm, for instance approximately 5 mm according to one embodiment. According to one embodiment, the glass fibre fabric can be a roll of fabric.

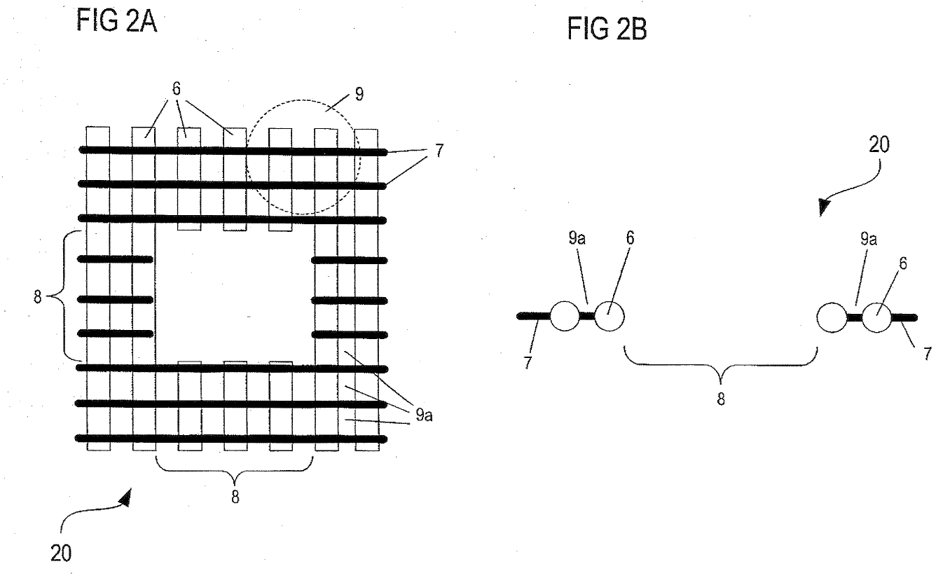

A regular grid of recesses 8 at the size of the RFID tags 1, that are to be integrated, are made within the substrate layer 20 (i.e., within the glass fibre fabric 9). FIG. 2A and FIG. 2B are depicting the substrate layer 20 including the formed recesses 8 therein, as a top view (FIG. 2A) and as a schematic cross section (FIG. 2B), For illustration, solely one recess 8 is depicted within the figures. However, there may be formed several, respectively a plurality of recesses 8 within the substrate layer 20.

The recesses 8 may for instance, be stamped or cut by laser beam, into the substrate layer 20. According to one embodiment, the recesses 8 may include for instance, a square shape at a size of, for instance, 5 cm×5 cm according to one embodiment. Alternatively, the recesses 8 may include another shape (e.g. rectangular, round, oval, or an arbitrary other shape) and/or size, for instance adapted to the shape and/or size of the RFID tags (in general, the electronic devices, that are to be integrated).

According to the depicted embodiment, the RFID tags 1 are integrated into the substrate layer 20. FIG. 3A and FIG. 3B depict the top view of the substrate layer 20 including the embedded (in other words integrated) RFID tag 1 (FIG. 3A) and the cross section (FIG. 3B). In addition to the RFID tag 1, depicted in FIG. 3A and FIG. 3B, more RFID tags 1 may be embedded within the substrate layer 20 (not shown).

According to the depicted embodiment herein, the RFID tags 1 are encapsulated within an encapsulation layer 5 (in other words, laminated with the encapsulation layer 5) prior to their embedding into the substrate layer 20. According to the depicted embodiment, the encapsulation. layer 5 is a thermoplastic plastic layer, and the RFID tags 1 are laminated with the thermoplastic plastic layer 5 on both sides (i.e. on top side and bottom side).

FIG. 5A and FIG. 5B depict a laminated RFID tag 1, in other words an RFID tag after encapsulation, in top view (FIG. 5A) and as a cross section (FIG. 55), according to one embodiment.

The RFID tags 1 may be RFID tags (e.g. passive RFID tags) suitable for the 13.56 MHz standard, for which the reading distance, when using a handheld antenna is approximately 10 cm. In other words, the RFID tags may be read up to a distance of approximately 10 cm, in this case. The RFID tags 1 may include a unique identification information (e.g. ID number) for the particular RFID tag 1, which may be read-out with a suitable reader.

Each RFID tag 1 may include, for instance, one on the top side of the RFID tag 1 formed antenna 2 (for instance, an inductor coil), one on the top side of the RFID tag 1 mounted chip 3 (e.g. a silicon chip), which is connected to the antenna 2, as well as a formed conductive bridge 4 (e.g. metal bridge) of the antenna on the bottom side, as depicted in FIG. 5A and FIG. 5B. By means of the lamination 5, the RFID tag 1 may be protected against pressure, humidity and chemical influences. Further, by means of the lamination 5 a height compensation may be achieved for the RFID tags 1. With other words, the laminated RFID tag 1 includes a planar top side and a planar bottom side.

The lamination 5 may be designed in such a way for instance, that it protrudes one or several sides of the RFID tag 1, for instance at least two opposite sides, for instance, approximately 0.5 cm up to 1 cm, according to one embodiment. In other words, the lamination 5 (the encapsulation layer 5) may protrude the edge of the RFID tag 1 on one or several sides, for instance on at least two opposite sides. According to the depicted embodiment in FIG. 5A and FIG. 5B, the lamination 5 is designed in such a way, that it is protruding the RFID tag 1 on all four sides.

After lamination the RFID tags I may be aligned to the corresponding recess 8 of the substrate layer 20 and be fixed in the substrate layer 20 under pressure and heat. In this process the protruding edges of the plastic layer 5 are jointed solidly to the reinforcement fabric 9 and are fixing the RFID tags 1, while simultaneously the different heights are compensated. In other words, the RFID tags 1 may be pasted to the substrate layer 20 (for instance to the glass fibre fabric), by using the plastic layer 5 (in general, the encapsulation layer 5). FIG. 3A shows the top view of an RFID tag 1 integrated into the reinforcement fabric 9, FIG. 3B shows the cross section.

According to another embodiment, the forming of the recesses 8 within the substrate layer 20 can be omitted (for instance within the glass fibre fabric 9), if the substrate layer 20 includes a very wide-meshed structure. For instance, it is possible to omit forming the recess/es 8, if the meshes of the fabric 9 are wide enough, so that the sensitive parts of the RFID tags 1 and accordingly of the radio modules 1 (e.g. the silicon chip 3 or the metal bridge 4 of the coil of the antenna 2) are positioned within a mesh 9a. In this case, the RFID tags 1 can be mounted on the substrate layer (for instance the reinforcement fabric 9), for instance can be glued to it, according to one embodiment.

FIG. 4A and FIG. 4B show a substrate layer 20 with an integrated RFID tag 1 therein, whereat during fabrication of the substrate layer, like described above, the forming of the recess/es within the fabric 9 was omitted and the RFID tag 1 was mounted on the fabric 9 accordingly, in such a way, that the chip 3 of the RFID tag 1 is positioned within a mesh 9a of the fabric 9. In other words, FIG. 4A and FIG. 4B show the top view and the cross section of the embodiment where the RFID tags 1 are integrated in a wide-meshed fabric without a recess. In the embodiment depicted in FIG. 4A and FIG. 4B, the RFID tags 1 is mounted on the bottom side of the fabric 9. Alternatively it is possible to mount the RFID tags 1 on the top side of the fabric 9.

According to another embodiment, it is possible to use another material, including a porous structure as a substrate layer instead of a reinforcement fabric (generally, instead of a material including a meshed structure) and that accordingly, the RFID tags (generally, the electronic devices) can be embedded into the porous material and/or can be mounted on it (not depicted).

The fabrication of the substrate layer 20 including the integrated RFID tags 1 therein, according to one of the described embodiments above, may be carried out, for instance, on a machine, which is suitable for a roll-to-roll production.

According to one embodiment, the RFID tags 1 may be read and tested after their integration into the substrate layer 20 by integrated readers during the process flow. Simultaneously, it is possible (for instance, by using a computer program and the corresponding software) to generate a mapping of the ID numbers of the RFID tags 1 within the roll. The mapping may be delivered together with the roll and therefore be provided to a customer or an installer. During the reading process it is also possible to store information of the manufacturer in the RFID tags 1. By using this, for instance, a life time monitoring of the flooring will be possible, i.e. a tracing during the whole life span of the flooring.

FIG. 6 schematically depicts a performance test of a substrate layer 20 including RFID tags 1 with simultaneous mapping of the RFID tags 1 on the roll, according to one embodiment. The substrate layer 20 includes a glass fibre fabric 9 with embedded and/or mounted RFID tags 1. The glass fibre fabric 9 including the REID tags is formed as a roll material, which may be unreeled from a first roll 18 and rolled-up into a second roll 19, wherein between both rolls 18, 19 a plurality of readers (FIG. 6 exemplarily depicts a first reader 21 and a second reader 22, alternatively a different number of readers may be used) and a control unit 23, which is coupled to the readers 21, 22, may read the RFID tags 1, create a mapping of the RFID tags 1, and accomplish a performance test. The mapping can be stored, for instance, on a standard data carrier 24 respectively data storage medium (e.g. CD ROM, DVD ROM, Disc, USB memory stick etc.) and may be delivered for instance together with the substrate layer 20 to the customer.

According to another embodiment, it is possible, that each individual RFID tag includes the mapping information of the entire roll. For this purpose, the RFID tags are designed in such a way, that the data storage of each RFID tag is large enough to store the mapping information. According to one embodiment, the mapping may be generated, after the integration of all RFID tags within the roll.

In the following, a method is described for producing a floor covering substrate with reference to FIG. 7A, according to one embodiment.

According to this method, a substrate layer 20 including integrated RFID tags 1 is embedded into a layer 11 consisting of a curable artificial resin material (for instance epoxy resin), in such a way that the floor covering substrate 25 is formed, like depicted in FIG. 7A.

According to an alternative embodiment, a layer including one or several other curable materials, e.g. a dispersion adhesive material or a mineral prime coat material may be used instead of the artificial resin layer 11.

The production of the substrate layer 20 including the integrated RFID tags 1 may be carried out according to the embodiment described in context with FIG. 1A up to FIG. 3B. Alternatively, the substrate layer 20 including the integrated RFID tags 1 (generally, the electronic devices) may be designed or be according to another embodiment described herein.

According to the embodiment depicted in FIG. 7A, the substrate layer 20 including the RFID tags 1 is formed as a roll material, respectively is shaped as a roll, for instance, in a similar way, like depicted schematically in FIG. 6.

The embedding of the substrate layer 20, including the integrated RFID tags 1 into the artificial resin layer 11 and, therefore, the forming of the floor covering substrate 25, may be carried out in a way, that the roll is installed on-site (i.e. at the location where a floor covering should be installed, respectively should be laid) on a floor pavement (floor screed) 10, where it is glued to the floor 10 with artificial resin and simultaneously covered by it. FIG. 7A depicts the floor covering substrate 25 formed on the floor pavement 10. Alternatively to the floor pavement (screed), the floor covering substrate 25 may be installed on another floor pavement.

According to the embodiment depicted in FIG. 8A up to FIG. 8C, the embedding of the substrate layer 20 may be established in a way, that a first sublayer 11a of artificial resin (generally, consisting of a first curable material) is applied to the floor pavement 10 (see FIG. 8A) and that the substrate layer 20 is installed on the first sublayer 11a and/or at least partly embedded into the first sublayer 11a (see FIG. 8B). Subsequently, a second sublayer 11b of artificial resin (generally, consisting of a second curable material, which may be the same as the first curable material, but this is not mandatory) can be applied to the first sublayer 11a and the substrate layer 20 (see FIG. 8C). Therefore, the first sublayer 11a and the second sublayer 11b are applied in a non-cured condition. If the substrate layer 20 includes a meshed structure or a porous structure, the material of the first sublayer 11a and the material of the second sublayer 11b may make at least partly contact. Subsequently, after curing of both sublayers 11a, 11b, a solid and robust joint is formed between sublayer 11a and sublayer 11b, wherein the substrate layer 20 including the RFID tags 1 is embedded in layer 11, which is formed by both sublayers 11a and 11b. Further a permanent joint is formed between the sublayer 11a and the floor pavement 10.

According to another embodiment, the substrate layer 20 may be integrated (e.g. embedded) into the non-cured first sublayer 11a, which is applied to the floor pavement 10, and subsequently the sublayer 11a including the integrated (e.g. embedded) substrate layer 20 may be cured, for fixing the sublayer 11a to the floor pavement 10. After curing the first sublayer 11a at least partly, the second sublayer 11b may be applied on the first sublayer 11a.

According to another embodiment depicted in FIG. 9A and FIG. 9B, the substrate layer 20 may be embedded into the artificial resin layer 11 in such a way, that the substrate layer 20 is installed on the floor pavement 10 (see FIG. 9A) and subsequently the artificial resin layer 11 is applied to the substrate layer 20 (see FIG. 9B). If the substrate layer 20 includes a meshed structure or a porous structure, then the material of the artificial resin layer 11 is at least partly able to penetrate through the meshes respectively the holes of the meshed/porous structure and make contact to floor pavement 10, so that a permanent joint is formed between the artificial resin layer 11 and the floor pavement 10 after curing of the artificial resin layer 11. Simultaneously, the substrate layer 20 including the RFID tags 1 is solidly fixed (respectively play-free) within the artificial resin layer 11.

According to another embodiment, it is possible to prepare the floor pavement by grinding and/or milling and/or grit blasting and/or suction cleaning, previous to the application of the first sublayer 11a or the layer 11 (e.g. a artificial resin layer) for improving the interconnect between the first sublayer 11a, respectively the layer 11 to the floor pavement 10. For instance it is possible to remove coarse roughness, cracks and gaps within the floor pavement 10, respectively renovate it.

Further, according to another embodiment it is possible, that prior to the application of the first sublayer 11a or the layer 11 a prime coating or another suitable first coating is applied to the floor pavement 10, for instance an artificial resin (e.g. epoxy resin), for eliminating the absorptive capacity and close the pores of the floor pavement 10.

Subsequently, the substrate layer 20 may be glued to the floor pavement permanently.

By means of the floor covering substrate 25 installed on the floor pavement 10, a floor pavement is provided, usable for all established flooring, like for instance stone, tiles, carpet, parquet, laminate and elastic flooring, except metal.

Subsequently, a floor covering 12 may be installed on the floor covering substrate 25, so that a flooring 50 is provided including a plurality of integrated RFID tags 1, as depicted in FIG. 7B. Illustratively, the flooring 50 includes a floor pavement 10 (screed)and a floor covering 12, as well as a floor covering substrate 25, located between the floor pavement 10 and the floor covering 12. The floor covering substrate 25 includes a substrate layer 20 with integrated RFID tags 1, embedded in curable layer 11, for instance a glass fibre fabric with integrated RFID tags embedded in artificial resin.

In the following a method is described in reference to FIG. 10A for producing a floor covering substrate according to another embodiment.

The main difference between this method in contrast to the method described in FIG. 7A is, that during the integration of the RFID tags 1 into the artificial resin layer 11 (generally into a curable layer) the substrate layer is omitted. In other words, the previously laminated RFID tags 1 (generally, the electronic devices) are directly embedded in the artificial resin 11, according to this embodiment, so that the floor covering substrate 25 is obtained, like depicted in FIG. 10A. This embodiment is suitable, for instance, for small areas or for embedding linear rows of RFID tags 1 in the floor covering respectively in the floor covering substrate 25. According to one embodiment, the RFID tags can be laid out manually and coated with the artificial resin layer 11. In this case, the mapping and/or the performance test of the RFID tags 1 is/are done for instance by manually reading the RFID tags 1 after installation and locating their position within the environment. The floor covering substrate 25 can be formed on a floor pavement (screed), for instance, as depicted in FIG. 10A.

Further, an arbitrary floor covering 12 may be installed on the floor covering substrate 25, so that, in turn, a flooring 50 including integrated RFID tags 1 is provided, as depicted in FIG. 10B.

In the following properties and effects of exemplary embodiments of the invention are described.

According to one embodiment, a method is provided, which allows the simple and cost-efficient integration of electronic devices (e.g. RFID tags) in a floor, wherein simultaneously, the electronic devices (e.g. RFID tags) are protected reliably against the high impact, they may be exposed to within the floor (e.g. pressure, humidity, chemicals).

According to another embodiment, a method is provided, which can be used for producing a high-quality floor covering for a flooring, or a floor covering substrate (underlay), that allows a free as possible choice of the upper, visible floor covering.

One effect of the described embodiment herein is that the electronic devices, especially the RFID tags, may be integrated in, respectively under an arbitrary floor covering, thus providing the possibility of localization in an arbitrary area, for the localization of moveable objects with and without accompanying human operator and/or all kind of robots and/or vehicles and/or persons, as well as the possibility of navigation through a central or local control unit.

Examples of use for the described localization/navigation by RFID tags integrated within the floor are, for instance, cleaning robots or transport vehicles, customer counting and customer guidance systems in the supermarket, airports, hospitals or generally, in public or private buildings.

An additional effect of the embodiments described herein is that the RFID tags, integrated efficiently in a regular grid in a substrate layer, may be installed beneath all common floorings—except metal—and (for instance, by using artificial resin) can be encapsulated in such a way, that they are protected against pressure, humidity and chemicals.

Simultaneously, it is possible to generate a map during the fabrication process, when integrating the RFID tags into the substrate layer, thus eliminating the need of a time-consuming mapping of single RFID tags on-site. According to one embodiment, it is possible to omit the underlay and to embed the laminated RFID tags directly into artificial resin, for instance, if only a small amount or single rows of RFID tags are to be installed. In this case, it is possible to generate the mapping on-site by a manual reading and localization of the REID tags.

According to one embodiment, a method is provided, whereby one or several RFID tags (generally, one or several electronic devices) are integrated into a substrate layer (for instance in a regular grid), which is suitable as a substrate layer within a floor covering substrate for carpet, linoleum, PVC, all other thinkable roll goods, tiles, stone flooring, concrete floor, Terrazzo or artificial resin flooring.

According to one embodiment, the substrate layer consists of rolled goods or larger panels. Examples for such a substrate layer are, e.g. reinforcement fabric consisting of glass fibres, polyethylene, polypropylene, polyester, carbon fibres or natural fibres.

Within these substrate layers, the RFID tags (generally, the electronic devices or electronic modules) are integrated (e.g. in a regular grid).

According to one embodiment, therefore, a recess in the size of an RFID tag is generated within the substrate layer for achieving a height compensation between the module and the substrate layer. The recess can be generated for instance by laser beam cutting, stamping, cutting, milling or another suitable method.

If the substrate layer consists of a very wide-meshed fabric, the recess can be omitted, according to another embodiment. In this case the embedding of the RFID tags can be established in a way, that sensitive areas of the RFID tags, like e.g. a silicon chip, are located within the meshes of the fabric.

According to one embodiment, the RFID tag may be encapsulated on both sides for achieving a height compensation on the RFID tag (between single components of the RFID tag, e.g. silicon chip, inlay, conductors, etc.), by using an encapsulation layer (for instance a thermoplastic plastic layer), and therefore providing a protection against mechanical and chemical influence, as well as humidity during installation.

According to one embodiment, the encapsulation layer is designed larger than the RFID tag and therefore can be used for fixing the RFID tag within the substrate layer, according to another embodiment.

According to another embodiment, the RFID tag is glued into the substrate layer under pressure and heat treatment.

According to another embodiment, the ID number of each RFID tag is read by a reader during the integration of the RFID tags into the substrate layer and therefore realising a performance test. According to another embodiment, the ID numbers were stored simultaneously by an according software. Thus a mapping of the roll material may be generated.

A roll may be delivered with this information (e.g. to a customer), so that it is sufficient during installation, for instance, reading solely the beginning and the end of a reel, for a fast determination of the physical position of each RFID tag within the room.

According to another embodiment, the installation of the substrate layer is done through embedding it into a curable layer, e.g. an artificial resin layer (for instance a epoxy resin layer), which includes a larger thickness as the substrate layer.

The respective floor pavement (e.g. all types of concretes and screeds, in exceptional cases tiles, all types of stone, all types of artificial stone, coatings) may be prepared in a way, which is free of separating substances, greases or oils. The floor pavement may be prepared by grinding and/or milling and/or grit blasting and/or suction cleaning for achieving an improved, respectively optimized interconnect to the floor pavement. Prior to that, possible coarse roughness, cracks and gaps may be removed, respectively renovated.

The respective floor pavement may be coated firstly, for instance, by artificial resin/epoxy resin or another suitable prime coat, for eliminating the absorptive capacity and close the pores of the floor pavement. Subsequently, the fabric may be glued to the floor pavement, by using artificial resin/epoxy resin or another suitable material.

According to one embodiment, the curable layer (for instance the artificial resin layer) covers the fabric (e.g. the reinforcement fabric) and/or the REID tags with a depth of approximately 0.1 mm up to 10 mm, for instance approximately 0.5 mm up to 4 mm, for instance approximately greater or equal 2 mm.

According to one embodiment, a bottom covering (floor covering) of a floor may be glued to the material in which the fabric is embedded by using an according material. The read distance of the REID tag readers is usually sufficiently high for allowing the building of all kinds of floors upon the floor covering, with the exception of metal floors, because they are shielding the electromagnetic field of the reader.

If an additional floor covering is applied to the artificial resin layer (generally the curable layer), the thickness of this layer can be minimized. According to one embodiment, in this case the thickness of the artificial resin layer may be approximately 0.1 mm up to 2 mm, for instance approximately 1 mm. Alternatively, the artificial resin layer may possess a different thickness.

According to another embodiment the substrate layer may be completely omitted (e.g. if only small areas or single REID tags are installed) and the REID tags, for instance encapsulated within a plastic layer, are directly embedded into the artificial resin layer. In this case, a mapping may be generated by reading each single REID tag and determine its position within the room.

Within this document following publications are cited:

[1] WO 2005/006015 A1

[2] WO 2005/071597 A1

[3] U.S. Pat. No. 6,377,888 B1

[4] http://openpr.de/pdf/78770/Intelligenter-Boden-steuert-intelligente-Serviceroboter.pdf

[5] http://www.still.de/9230.0.43.html

[6] http://www.still.de/?id=9240#35660

[7] WO 2007/033980 A2

1. A method for producing a floor covering substrate, the method comprising:
embedding at least one electronic device within a layer, which comprises at least one curable material;
at least one of introducing the at least one electronic device in a substrate layer and applying the at least one electronic device on a substrate layer; and
embedding the substrate layer, comprising the electronic device embedded in a layer, which comprises at least one curable material;
wherein the substrate layer comprises a porous or meshed structure or a reinforcement fabric, which is penetrable for the at least one curable material.

2. The method of claim 1,
wherein the at least one curable material comprises at least one of the following materials:
an artificial resin material;
a dispersion adhesive material;
a mineral prime coat material; and
a mixture of the above named materials.

3. The method of claim 1,
wherein the at least one electronic device is at least one of applied to and at least partly embedded into a first sublayer, which comprises a curable material;
wherein a second sublayer, which comprises a second curable material, is applied to the first sublayer and the electronic device, so that the layer is formed, that comprises at least one electronic device.

4. (canceled)

5. The method of claim 1,
wherein a plurality of electronic devices is at least one of integrated in a regular grid into the substrate layer and applied to the substrate layer.

6. (canceled)

7. The method of claim 1,
wherein at least one recess is formed within the substrate layer and the at least one electronic device is integrated within the at least one recess.

8. The method of claim 7,
wherein the at least one recess is formed by one of the following methods
laser beam cutting;
stamping;
cutting; and
milling

9. The method of claim 1,
wherein the at least one electronic device is encapsulated within an encapsulation layer prior to the embedding.

10. The method of claim 1,
wherein the at least one electronic device is encapsulated within an encapsulation layer, prior to the at least one of embedding it into the substrate layer and applying it to the substrate layer, and by using the encapsulation layer for gluing it to the substrate layer.

11. (canceled)

12. A method for the integration of at least one electronic device in a flooring, the method comprising:
providing a floor covering substrate by using a method for producing a floor covering substrate, the method comprising:
embedding at least one electronic device within a layer, which comprises at least one curable material;
at least one of introducing the at least one electronic device in a substrate layer and applying the at least one electronic device on a substrate layer;
embedding the substrate layer, comprising the electronic device in a layer, which comprises at least one curable material;
wherein the substrate layer comprises a porous or meshed structure or a reinforcement fabric, which is penetrable for the at least one curable material;
installing a floor covering on a floor covering substrate.

13. A floor covering substrate, comprising:
a layer, which comprises at least one curable material;
at least one electronic device, which is embedded in a layer; and
a substrate layer;
wherein the at least one electronic device is at least one of embedded in the substrate layer and applied to the substrate layer;
wherein the substrate layer comprising the electronic device is embedded within the layer; and
wherein the substrate layer comprises, for the at least one curable material, a porous structure or a meshed structure or the substrate layer is a reinforcement fabric.

14. The floor covering substrate of claim 13,
wherein the at least one curable material comprises one of the following materials:
an artificial resin material;
a dispersion adhesive material;
a mineral prime coat material; and
a mixture of the above named materials.

15. The floor covering substrate of claim 13,
wherein the layer comprises a first sublayer and a second sublayer;
wherein the first sublayer comprises a first curable material;
wherein the second sublayer comprises a second curable material;
wherein the at least one electronic device is at least one of applied to the first sublayer and at least partly embedded into the first sublayer; and
wherein the second sublayer is applied to the first sublayer and the electronic device.

16. The floor covering substrate of claim 15,
wherein at least one of the first curable material and the second curable material comprises at least one of the following materials:
an artificial resin material;
a dispersion adhesive material;
a mineral priming coat material; and
a mixture of the above named materials.

17. The floor covering substrate of claim 13,
wherein a plurality of electronic devices is at least one of integrated in a regular grid within the substrate layer and applied to the substrate layer.

18. The floor covering substrate of claim 13,
wherein the reinforcement fabric comprises at least one of the following materials:
a glass fibre material;
polyethylene;
polypropylene;
polyester;
a carbon fibre material;
a natural fibre material; and
metal wires.

19. The floor covering substrate of claim 13,
wherein least one recess is formed within the substrate layer and the at least one electronic device is integrated into the at least one recess.

20. The floor covering substrate of claim 13,
wherein the at least one electronic device is encapsulated within an encapsulation layer.

21. The floor covering substrate of claim 13,
wherein the at least one electronic device is encapsulated within an encapsulation layer and is glued to the substrate layer be using the encapsulation layer.

22. The floor covering substrate of claim 13,
wherein the at least one electronic device is a radio frequency identification data storage.

23. A flooring with at least one integrated electronic device, the flooring comprising:
a floor covering substrate, comprising:
a layer, which comprises at least one curable material;
at least one electronic device, which is embedded in a layer; and
a substrate layer;
wherein the at least one electronic device is at least one of embedded in the substrate layer and applied to the substrate layer;
wherein the substrate layer comprising the electronic device is embedded within the layer; and
wherein the substrate layer comprises, for the at least one curable material,
a porous structure or a meshed structure or the substrate layer is a reinforcement fabric;
a floor covering being installed on the floor covering substrate.

24.-40. (canceled)
